(19) United States
(12) Patent Application Publication
(10) Pub. No.: US 2026/0264642 A1
(43) Pub. Date: Sep. 10, 2026

(54) VEHICLE PROTECTION AND RECOVERY APPARATUS

(71) Applicant: José Alfonso Plácido Tineo, Distrito Nacional (DO)

(72) Inventor: José Alfonso Plácido Tineo, Distrito Nacional (DO)

(73) Assignee: José Alfonso Plácido Tineo, Distrito Nacional (DO)

(21) Appl. No.: 19/075,169

(22) Filed: Mar. 10, 2025

(51) Int. Cl. B60R 25/09; B60R 25/102; B60R 25/33; B60R 25/40

(52) U.S. Cl. CPC B60R 25/09; B60R 25/102; B60R 25/33; B60R 25/403; B60R 2325/10; B60R 2325/101; B60R 2325/106; B60R 2325/205

(57) ABSTRACT

A vehicle security apparatus is provided for locking and unlocking vehicle wheels. The apparatus includes a housing that encases a servomotor, a worm screw, a cylindrical container, a pivot, a perforated band, a compression spring, one or more internal screws, a latch, a clamp, a blocking system, and an electronic compartment including a battery and a motherboard. The housing is mounted to the clamp using one or more internal screws, with the clamp precisely aligned and secured within up to 100 mm of the vehicle's shock absorber and/or suspension system. The perforated band, which may include up to 50 holes, is affixed to the vehicle's wheel rim. The servomotor, connected to the battery, drives the worm screw that is operably linked to the cylindrical container to facilitate pivot movement through engagement with internal threading. Additionally, a method for activating the vehicle security apparatus for locking and unlocking the vehicle is provided.

### CROSS-REFERENCE TO RELATED APPLICATIONS

This is an original Nonprovisional Application and does not claim benefit to any prior applications.

### FEDERALLY SPONSORED RESEARCH AND DEVELOPMENT

Not applicable.

The current invention relates to the field of vehicle security systems and, more particularly, to apparatus and methods for locking and unlocking vehicle wheels using an integrated mechanical and electronic approach.

### BACKGROUND OF THE INVENTION

Vehicle security systems are crucial in preventing theft or unauthorized vehicle access, and various methods have been developed to address these concerns. The vehicle security industry continues to seek enhanced solutions for preventing theft and unauthorized access to vehicles. Recently, the market has seen a rise in technologies aimed at providing advanced security measures through mechanical and electronic systems. Traditional systems often focus on securing the vehicle through mechanical means, such as wheel locks or steering wheel immobilizers. However, these systems are frequently limited in terms of user convenience, reliability, and vulnerability to tampering. Current methods often fail to provide secure, automated, or remotely activated locking features that could enhance the overall security of the vehicle. Therefore, there is a need for improved systems that address these limitations and offer more sophisticated, user-friendly solutions for modern vehicles.

### SUMMARY OF THE INVENTION

A vehicle security apparatus including: a housing encasing, a servomotor, a worm screw, a cylindrical container, a pivot, a perforated band, a compression spring, a screw, a latch, and an electronic compartment further including a battery and a motherboard, wherein the housing encasing houses the servomotor, the worm screw, the cylindrical container, the pivot, the perforated band, the compression spring, the screw, the latch, and the electronic compartment, and wherein the housing encasing mounts the apparatus onto a vehicle shock absorber and/or suspension system.

A vehicle security apparatus including: a housing encasing, a servomotor, a worm screw, a cylindrical container, a pivot, a perforated band, a compression spring, one or more internal screws, a latch, a clamp, a blocking system, and an electronic compartment, wherein the electronic compartment further including a battery and a motherboard, wherein the housing encasing is mounted to the clamp by one or more internal screws, wherein the clamp is secured with precise alignment within up to 100 mm to the vehicle shock absorber and/or suspension system, wherein the perforated band includes of up to 50 holes, wherein the perforated band is fixed to the vehicle wheel rim, wherein the servomotor is fixed within the housing encasing and is connected to the battery, wherein the worm screw is connected to the servomotor, wherein the worm screw is connected to the cylindrical container, wherein the worm screw is configured to enable the pivot movement, wherein the pivot movement engages with the cylindrical container with internal threading, and wherein the apparatus is configured to lock and unlock vehicle wheels.

A vehicle security apparatus is provided for locking and unlocking vehicle wheels. The apparatus includes a housing encasing a servomotor, a worm screw, a cylindrical container, a movable pivot, a perforated band, a compression spring, one or more internal screws, a latch, a clamp, a blocking system, and an electronic compartment further comprising a battery and a motherboard. The vehicle comprises at least one wheel with a rim and a vehicle shock absorber. The housing encasing is mounted to the clamp by one or more internal screws, with the clamp precisely aligned and secured within up to 100 mm of the vehicle's shock absorber and/or suspension system. The perforated band, which may include up to 50 holes, is affixed to the vehicle's wheel rim. The servomotor, connected to the battery, drives the worm screw that is operably linked to the cylindrical container to facilitate pivot movement through engagement with internal threading. The apparatus is configured to lock and unlock vehicle wheels.

In some aspects, the techniques described herein may relate to the clamp may be secured with an adjustable alignment that starts from the axis of the rim, which contains the pivot that is precisely positioned up to 100 mm on the perforated band., which allows greater precision when activating the block system that penetrates.

In some aspects, the techniques described herein may relate to the housing encasing protection from environmental elements the servomotor, the worm screw, the cylindrical container, the pivot, the perforated band, the compression spring, —the latch, a locking system, and the electronic compartment; and wherein the housing encasing is made of high-strength polymer, for example, Kevlar (Aramid fibers), Ultem (Polyetherimide—PEI), Polycarbonate (PC), Polyphenylene Sulfide (PPS), Polyether Ether Ketone (PEEK), Nylon (Polyamide), High-Density Polyethylene (HDPE), Liquid Crystal Polymers (LCPs), and any combination thereof.

In some embodiments, the housing encasing protects the servomotor, the worm screw, the cylindrical container, the pivot, the perforated band, the compression spring, the latch, the locking system, and the electronic compartment from environmental elements. The housing encasing may be made of high-strength polymer, such as Kevlar (Aramid fibers), Ultem (Polyetherimide—PEI), Polycarbonate (PC), Polyphenylene Sulfide (PPS), Polyether Ether Ketone (PEEK), Nylon (Polyamide), High-Density Polyethylene (HDPE), Liquid Crystal Polymers (LCPs), and any combination thereof.

In some aspects, the techniques described herein may relate to the precise alignment that allows the pivot movement to engage with the one perforated band hole when locking is activated and wherein the engagement is configured to lock vehicle wheels.

In some embodiments, the precise alignment allows the pivot movement to engage with one hole of the perforated band when locking is activated, securing the vehicle wheels. The latch regulates pivot movement during locking and unlocking. The compression spring, positioned alongside the pivot, maintains a tension of 12.6 N and ensures proper alignment with the perforated band holes. The internal screws secure the assembly, with the latch configured as a mechanical stop to limit the pivot's upward movement to 5-7 mm.

In some aspects, the techniques described herein may relate to the latch regulating pivot movement during locking and unlocking.

In some aspects, the techniques described herein may relate to the servomotor that may be mounted within the encasing and is connected to the worm screw and wherein the worm screw is connected to the cylindrical container.

In some aspects, the techniques described herein may relate to the worm screw that may be connected to and configured to enable the pivot movement and wherein the pivot movement engages the perforated band.

In some aspects, the techniques described herein may relate to the compression spring located alongside the pivot and configured to maintain tension. Keep the pivot extended until it coincides with one of the holes in the perforated band if it does not fit directly into one of the holes, which may happen when moving the motorcycle forward or backward.

In some aspects, the techniques described herein may relate to the screws that may secure the overall assembly, wherein the The latch is configured as a mechanical stop to limit the pivot's upward movement. It ensures that the pivot remains extended until it aligns with one of the perforations in the band. If the pivot does not immediately engage, movement of the vehicle (forward or backward) allows the spring to adjust the alignment.

In some aspects, the techniques described herein may relate to the battery that may connect to the servomotor, screws, and the cylindrical container.

In some aspects, the techniques described herein may relate to the motherboard having a remote interface with the servomotor, wherein the remote interface may be configured to lock and unlock the vehicle remotely.

In some aspects, the techniques described herein may relate to the electronic compartment having Real-Time Operating System (RTOS) such as Zephyr RTOS, wherein the RTOS may connect with the servomotor, worm screw, cylindrical container, pivot, perforated band, compression spring, latch, and electronic compartment, and the RTOS enables coordinated operation of the locking mechanism. Zephyr RTOS type of architecture makes it suitable for use on limited-resource devices and in devices deployed to resource-constrained environments.

In some aspects, the techniques described herein may relate to the electronic compartment, including a motherboard with a remote interface configured to lock and unlock the vehicle remotely. The apparatus may integrate a Real-Time Operating System (RTOS) such as Zephyr RTOS, connecting the servomotor, worm screw, cylindrical container, pivot, perforated band, compression spring, latch, and electronic compartment to enable coordinated operation of the locking mechanism. The electronic compartment may include proximity sensors, motion sensors, tilt sensors, Bluetooth, GPS, GSM, WiFi, IoT, SMS/MMS communication modules, or any combination thereof.

In some aspects, the techniques described herein may relate to the electronic compartment being configured to send customizable alerts, notifications, and/or alarms, provide real-time location tracking, enable geofencing, and support vehicle recovery. Additionally, it includes a user management module for authentication, registration, access control, remote functionality, real-time notifications, and user-customizable settings. The centralized monitoring and control platform enables real-time vehicle monitoring, remote control of the apparatus, firmware updates, and geofencing.

In some aspects, the techniques described herein may relate to the electronic compartment may have one or more selected from a group consisting of RTOS, proximity sensors, motion sensors, tilt sensors, Bluetooth, GPS, GSM, WiFi, IoT, SMS/MMS communication modules, and any combination thereof.

In some aspects, the techniques described herein may relate to the electronic compartment that may be configured to send customizable alerts, notifications, and/or alarms.

In some aspects, the techniques described herein may relate to the electronic compartment may be configured for real-time location tracking.

In some aspects, the techniques described herein may relate to the electronic compartment configured for real-time geofencing.

In some aspects, the techniques described herein may relate to the electronic compartment may be adapted to recover the vehicle.

In some aspects, the techniques described herein may relate to the electronic compartment that may be adapted for the vehicle's real-time monitoring and control.

In some aspects, the techniques described herein may relate to the electronic compartment that may have a user management module, and the user management module may secure the apparatus authentication, registration, access control, remote functionality, real-time notifications, user-customizable settings, and any combination thereof.

In some aspects, the techniques described herein may relate to the user management module configured to be used by one or more users in real time.

In some aspects, the techniques described herein may relate to the electronic compartment with a centralized monitoring and control platform.

In some aspects, the techniques described herein may relate to the centralized monitoring and control platform configured for real-time vehicle monitoring.

In some aspects, the techniques described herein may relate to the centralized monitoring and control platform configured for remote apparatus control.

In some aspects, the techniques described herein may relate to the centralized monitoring and control platform that may be configured for customizable alerts and/or notifications.

In some aspects, the techniques described herein may relate to the centralized monitoring and control platform that may be configured for geo-fencing.

In some aspects, the techniques described herein may relate to the centralized monitoring and control platform that may be configured for firmware updates.

### Method for Activating the Vehicle Security Apparatus

A method is provided for activating a vehicle security apparatus for locking and unlocking vehicle wheels. The method includes:

### I. Locking the Vehicle Wheels:

Powering the servomotor via the battery.

Rotating the worm screw to drive the cylindrical container.

Moving the cylindrical container downward, pushing the pivot toward the perforated band.

Inserting the pivot into one of the perforated band holes when alignment occurs.

Compressing the spring to maintain pressure and retrying alignment if necessary.

Locking the perforated band to stop wheel movement.

### II. Unlocking the Vehicle Wheels:

Powering the servomotor to reverse the worm screw rotation.

Retracting the cylindrical container and pulling the pivot out of the perforated band.

Unlocking the perforated band and allowing wheel movement.

### III. Resetting the Apparatus for the Next Use:

Retracting the pivot and deactivating the servomotor and worm screw.

Preparing the apparatus for the next locking cycle.

In some embodiments, the electronic compartment allows remote locking/unlocking via a smart device. The system ensures security by preventing unauthorized wheel movement, detects tampering through onboard sensors, and notifies the user if pivot alignment fails.

### BRIEF DESCRIPTION OF FIGURES AND DRAWINGS

FIG. 1 shows a side view of the apparatus and its internal mechanism.

FIG. 2. Technical Drawing of a Linear Locking Component.

FIG. 3. Drawing of a Threaded Fastener.

FIG. 4. Technical Drawing of a Locking pin and/or pivot. T

FIG. 5. Drawing of a Locking Shaft.

FIG. 6. Drawing of a Locking Coupling.

FIG. 7. Technical Drawing of a perforated band of Locking Mechanism.

FIG. 8. Drawing of a Locking Arm.

FIG. 9. Main Body Technical Drawing.

FIG. 10. Profile View of Main Body Component.

FIG. 11. displays the Locking System with various components.

FIG. 12A. depicts the Locking System installed with a wheel when the electronics are covered.

FIG. 12B. depicts the Locking System installed with a wheel when the electronics are uncovered.

FIG. 12C depicts a closer view of the perforated band and the clamp.

FIG. 13 shows the locking system firmly attached to the motorcycle via the clamp, with the perforated band aligned for effective operation.

FIG. 14. showcases the Locking System mounted on an automobile such as a motorcycle, emphasizing the following key components:

FIG. 15. Shows the Clamp.

FIG. 16. This focuses on the Pivot.

TABLE. 1. A Method for activating a vehicle security apparatus for locking and unlocking the vehicle.

### DETAILED DESCRIPTION OF THE INVENTION

Examples of embodiments are provided so that this disclosure will be thorough and fully convey the scope to those skilled in the art. Numerous specific details are set forth, such as examples of specific components, devices, and methods, to provide a thorough understanding of the embodiments of the present disclosure. It will be apparent to those skilled in the art that specific details need not be employed, that example embodiments may be embodied in many different forms, and that neither should be construed to limit the scope of the disclosure. In some examples, embodiments, aspects, well-known processes, well-known device structures, and well-known technologies are not described in detail least one specification heading is required.

The terminology used herein is for the purpose of describing particular example embodiments only and is not intended to be limiting. As used herein, the singular forms “a,” “an,” and “the” may be intended to include the plural forms as well unless the context clearly indicates otherwise. The terms “includes,” “including,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “including” or “having” an element or a plurality of elements having a particular property may include additional such elements not having that property. When a definition is provided herein, it supersedes any other meaning or definition.

The disclosure therein aims to solve a security problem, including technology and the analog market of security apparatus, using technological advances that allow more control, greater comfort, and safety for users by blocking and releasing the movement of the vehicle's wheel automatically.

The apparatus and the system of this disclosure provide an alternative locking system primarily for vehicles with a remote locking mechanism capability. The apparatus may also further provide a recovery mechanism.

A vehicle security apparatus including a housing encasing, a servomotor, a worm screw, a cylindrical container, a pivot, a perforated band, a compression spring, a screw, a latch, and an electronic compartment further including a battery and a motherboard, wherein the housing encasing houses the servomotor, the worm screw, the cylindrical container, the pivot, the perforated band, the compression spring, the screw, the latch, and the electronic compartment, and wherein the housing encasing mounts the apparatus onto a vehicle shock absorber and/or suspension system.

A vehicle security apparatus including: a housing encasing, a servomotor, a worm screw, a cylindrical container, a movable pivot, a perforated band, a compression spring, one or more internal screws, a latch, a clamp, a blocking system, and an electronic compartment, wherein the electronic compartment further including a battery and a motherboard, wherein the housing encasing is mounted to the clamp by one or more internal screws, wherein the clamp is secured with precise alignment within up to 100 mm to the vehicle shock absorber and/or suspension system, wherein the perforated band includes of up to 50 holes, wherein the perforated band is fixed to the vehicle wheel rim, wherein the servomotor is fixed within the housing encasing and is connected to the battery, wherein the worm screw is connected to the servomotor, wherein the worm screw is connected to the cylindrical container, wherein the worm screw is configured to enable the pivot's movement, wherein the pivot movement engages with the cylindrical container with internal threading, and wherein the apparatus is configured to lock and unlock vehicle wheels.

A vehicle security apparatus is provided for locking and unlocking vehicle wheels. The apparatus includes a housing encasing a servomotor, a worm screw, a cylindrical container, a movable pivot, a perforated band, a compression spring, one or more internal screws, a latch, a clamp, a blocking system, and an electronic compartment further comprising a battery and a motherboard. The vehicle comprises at least one wheel with a rim and a vehicle shock absorber. The housing encasing is mounted to the clamp by one or more internal screws, with the clamp precisely aligned and secured within up to 100 mm of the vehicle's shock absorber and/or suspension system. The perforated band, which may include up to 50 holes, is affixed to the vehicle's wheel rim. The servomotor, connected to the battery, drives the worm screw that is operably linked to the cylindrical container to facilitate pivot movement through engagement with internal threading. The apparatus is configured to lock and unlock vehicle wheels.

In some embodiments, the housing encasing protects the servomotor, the worm screw, the cylindrical container, the pivot, the perforated band, the compression spring, the latch, the locking system, and the electronic compartment from environmental elements. The housing encasing may be made of high-strength polymer, such as Kevlar (Aramid fibers), Ultem (Polyetherimide—PEI), Polycarbonate (PC), Polyphenylene Sulfide (PPS), Polyether Ether Ketone (PEEK), Nylon (Polyamide), High-Density Polyethylene (HDPE), Liquid Crystal Polymers (LCPs), and any combination thereof.

In some embodiments, the precise alignment allows the pivot movement to engage with one hole of the perforated band when locking is activated, securing the vehicle wheels. The latch regulates pivot movement during locking and unlocking. The compression spring, positioned alongside the pivot, maintains a tension of 12.6 N and ensures proper alignment with the perforated band holes. The internal screws secure the assembly, with the latch configured as a mechanical stop to limit the pivot's upward movement to 5-7 mm.

In some aspects, the techniques described herein may the electronic compartment includes a motherboard with a remote interface configured to lock and unlock the vehicle remotely. The apparatus may integrate a Real-Time Operating System (RTOS) such as Zephyr RTOS, connecting the servomotor, worm screw, cylindrical container, pivot, perforated band, compression spring, latch, and electronic compartment to enable coordinated operation of the locking mechanism. The electronic compartment may include proximity sensors, motion sensors, tilt sensors, Bluetooth, GPS, GSM, WiFi, IoT, SMS/MMS communication modules, or any combination thereof.

In some aspects, the techniques described herein may the electronic compartment is configured to send customizable alerts, notifications, and/or alarms, provide real-time location tracking, enable geofencing, and support vehicle recovery. Additionally, it includes a user management module for authentication, registration, access control, remote functionality, real-time notifications, and user-customizable settings. The centralized monitoring and control platform enables real-time vehicle monitoring, remote control of the apparatus, firmware updates, and geofencing.

In some aspects, the cylindrical container may be a threaded cylindrical container, and herein, these terms are used interchangeably.

In some aspects, the motorcycle locking apparatus may be made of several key components designed for effective performance and protection. The first part is a casing that houses all electronic components and the disclosing apparatus responsible for generating the lock. The second part provides a hermetic coupling to ensure that the first part remains sealed. The third part is an additional casing that further encloses all electronic components securely. The fourth part is a conically drilled disc, precisely synchronized to facilitate the automatic locking mechanism of the disclosing apparatus, acting as a receiver. The system of current disclosure employs an analog mechanical application, and both the housing design and coupling features are unique to this application, enhancing the overall functionality and security of the locking system. The lock system, the case, the electronic composition and the configuration or software.

In some aspects, the techniques described herein may relate to the clamp may be secured with an adjustable alignment that starts from the axis of the rim, which contains the pivot that is millimetrically, up to 200 mm, positioned on the perforated band, which allows greater precision when activating the block system that penetrates. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200 mm, and any combination thereof.

In some aspects, the techniques described herein may relate to the housing encasing protection from environmental elements the servomotor, the worm screw, the cylindrical container, the movable pivot, the perforated band, the compression spring, —the latch, a locking system, and the electronic compartment.

In some aspects, the techniques described herein may relate to what housing encasing may be made of high-strength polymer, for example, Kevlar (Aramid fibers), Ultem (Polyetherimide—PEI), Polycarbonate (PC), Polyphenylene Sulfide (PPS), Polyether Ether Ketone (PEEK), Nylon (Polyamide), High-Density Polyethylene (HDPE), Liquid Crystal Polymers (LCPs), and any combination thereof.

In some aspects, the techniques described herein may relate to some components, such as the Main Housing, Fork Grip, and Crown may be made of molded ABS (Acrylonitrile Butadiene Styrene), ABS reinforced with or without fiberglass, Polycarbonate (PC) Reinforced with/without Fiberglass, Nylon (PA6 or PA66) with/without Fiberglass Reinforcement, Glass-Filled Polypropylene (GF-PP), Acetal (POM—Polyoxymethylene) with Fiberglass, Carbon Fiber Reinforced Polymer (CFRP), Ultem (Polyetherimide—PEI) Reinforced with Fiberglass, and/or any combination thereof.

In some aspects, the techniques described herein may relate to the precise alignment that allows the pivot's movement to engage with the one perforated band hole when locking is activated, and the engagement may be configured to lock vehicle wheels.

In some aspects, the techniques described herein may relate to the latch regulating pivot movement during the locking and unlocking of the vehicle wheels.

In some aspects, the techniques described herein may relate to the servomotor that may be mounted within the encasing and is connected to the worm screw and wherein the worm screw is connected to the cylindrical container.

In some aspects, the techniques described herein may relate to the battery connects to the servomotor and the cylindrical container through fastening such as fastening screws, fastening electrical screws, fastening electrical connections, etc., and/or any combination thereof.

In some aspects, the techniques described herein may relate to the worm screw that may be connected to and configured to enable the pivot movement and wherein the pivot movement engages the perforated band. Herein, the term “engages” refers to the action of the pivot making contact with the perforated band and fitting into at least one of its holes. Essentially, engagement means that the Pivot may be positioned correctly within the band to perform its locking function

In some aspects, the techniques described herein may relate to this connection that may effectively secure the motorcycle by preventing movement, as the pivot holds the perforated band in place, locking the system when activated.

In some aspects, the techniques described herein may relate to the vehicle locking apparatus. Screws may play a crucial role by fastening and stabilizing the various components of the assembly, ensuring that everything remains securely in place. They may provide structural integrity and prevent parts from loosening or separating during operation.

In some aspects, the techniques described herein may relate to the compression spring in the apparatus designed to maintain tension alongside the pivot, ensuring secure engagement within the locking mechanism. The compression spring may have an elastic constant of 0.63 N/mm. With a deformation of 20 mm, the resulting tension force is calculated as 12.6 N, effectively maintaining pressure within the system.

In some aspects, the techniques described herein may relate to the compression spring located alongside the pivot and configured to maintain the tension of up to 20 N, for example, 5, 6, 7, 8, 9, 10, 11, 12, 13, 14, 15, 16, 17, 18, 19, 20 N, and/or any combination thereof.

In some aspects, the techniques described herein may relate to the latch, positioned to limit the upward movement of the pivot, which functions as a mechanical stop to prevent unintended disengagement. Given that the pivot length in the locked state is 13 mm, the latch restricts upward movement to an estimated range of 5 to 7 mm, for example, 5, 5.1. 5.2, 5.3, 5.4, 5.5, 5.6, 5.7, 5.8. 5.9, 6.0, 6.1. 6.2, 6.3, 6.4, 6.5, 6.6, 6.7, 6.8. 6.9, 7.0, etc. This may ensure controlled retraction while preventing accidental unlocking and maintaining the integrity of the locking mechanism.

In some aspects, the techniques described herein may relate to the latch; on the other hand, it serves a specific purpose by restricting the upward movement of the pivot. It may act as a mechanical stop, ensuring that the pivot may not rise too high when the locking system is deactivated. This combination of screws and the latch may work together to maintain the proper alignment and positioning of the pivot, ensuring the locking mechanism functions effectively and safely. The upward movement may be up to 20 mm, for example, 1, 2, 3, 4, 5, 6, 7, 8, 9, 10, 11, 12, 13, 14, 15, 16, 17, 18, 19, 20 mm and/or combination thereof.

In some aspects, the techniques described herein may relate to the screws that may secure the overall assembly, wherein the latch may be positioned to limit the upward movement of the pivot and configured as a mechanical stop. The upward movement may be up to 20 mm, for example, 1, 2, 3, 4, 5, 6, 7, 8, 9, 10, 11, 12, 13, 14, 15, 16, 17, 18, 19, 20 mm and/or combination thereof.

In some aspects, the techniques described herein may relate to the battery that may connect to the servomotor, screws, and the cylindrical container.

In some aspects, the techniques described herein may relate to the motherboard having a remote interface with the servomotor, wherein the remote interface may be configured to lock and unlock the vehicle remotely by, for example, a remote control and/or like. The remote control may be integrated into other devices such as an APP on a smartphone, car keys, computer, etc., and/or any combination thereof

In some aspects, the techniques described herein may relate to the servomotor integration that may utilize a servomotor that works in conjunction with a worm screw to facilitate the mechanical movement required for locking and unlocking the apparatus and, thus, the vehicle.

In some aspects, the techniques described herein may relate to the cylindrical container action designed to slide downward, enabling the pivot to insert into the perforated band for effective locking and unlocking actions.

In some aspects, the techniques described herein may relate to the regaining pressure function of the spring, which may include a compression spring that retains pressure on the pivot until it engages correctly with the holes in the perforated band, enhancing the reliability of the locking mechanism.

In some aspects, the techniques described herein may relate to the high-resistance pivot that may be made of highly resistant material to withstand the acceleration forces of the motorcycle, ensuring it effectively blocks the rotation of the perforated band. made of highly resistant materials such as steel, Titanium (Grade 5/Ti-6Al-4V), Carbon Steel (1045 or 4140 Alloy Steel), Aluminum (7075 or 6061-T6), Brass (C360 or C464 Naval Brass). Polymer-Based Composite (PEEK—Polyether Ether Ketone), and/or any combination thereof.

In some aspects, the techniques described herein may relate to the perforated band design with multiple holes oriented inward, allowing for a greater margin of sliding for the pivot to align properly during locking. For example, 1, 2, 3, 4, 5, 6, 7, 8, 9, 10, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 holes, and any combination thereof.

In some aspects, the techniques described herein may relate to the locking system that may feature a latch that prevents the pivot from rising excessively when deactivated, ensuring proper alignment and function during operation.

In some aspects, the techniques described herein may relate to the electronic compartment having Real-Time Operating System (RTOS) such as Zephyr RTOS, wherein the RTOS may connect with the servomotor, worm screw, cylindrical container, pivot, perforated band, compression spring, latch, and electronic compartment, and the RTOS enables coordinated operation of the locking mechanism.

In some aspects, the techniques described herein may relate to the microcontroller with Real-Time Operating System (RTOS—for example, Zephyr), which may ensure efficient processing and responsiveness. The term “Microcontroller with Real-Time Operating System (RTOS—Zephyr)” refers to a microcontroller that may be running the RTOS that may be a highly modular real-time operating system that may allow a user to include one or more of the necessary components for their specific applications, thereby reducing resource usage. It may support multi-threading, enable the concurrent execution of multiple processes, and provide various methods for inter-thread communication, such as message queues and semaphores. Additionally, it may offer robust networking capabilities, making it suitable for Internet of Things (IoT) applications.

In some aspects, the techniques described herein may relate to the electronic compartment may have one or more selected from a group consisting of RTOS, proximity sensors, motion sensors, tilt sensors, Bluetooth, GPS, GSM, WiFi, IoT, SMS/MMS communication modules, a motherboard, one or more sensors configured to detect proximity, Bluetooth, infrared, Gyroscope, WiFi, GPS, GSM, MMS, and SMS and any combination thereof.

In some aspects, the techniques described herein may relate to the apparatus, which may be a smart lock with internet connectivity.

In some aspects, the techniques described herein may relate to the apparatus enabling intelligent locking mechanisms and capabilities.

In some aspects, the techniques described herein may relate to the electronic compartment that may be configured to send customizable alerts, notifications, and/or alarms.

In some aspects, the techniques described herein may relate to the electronic compartment may be configured for real-time location tracking.

In some aspects, the techniques described herein may relate to the electronic compartment configured for real-time geofencing.

In some aspects, the techniques described herein may relate to the electronic compartment may be adapted to recover the vehicle.

In some aspects, the techniques described herein may relate to the electronic compartment that may be adapted for the vehicle's real-time monitoring and control.

In some aspects, the techniques described herein may relate to the electronic compartment that may have a user management module, and the user management module may secure the apparatus authentication, registration, access control, remote functionality, real-time notifications, user-customizable settings, and any combination thereof.

In some aspects, the techniques described herein may relate to the user management module configured to be used by one or more users in real time.

In some aspects, the techniques described herein may relate to user management that may facilitate administering two or more different users who can access the apparatus to manage users effectively. For example, 1, 2, 3, 4, 5, 6, 7, 8, 9, 10, 11, 12, 13, 14, 15, 16, 17, 18, 19, 20, etc., users and any combination thereof.

In some aspects, the techniques described herein may relate to the electronic compartment with a centralized monitoring and control platform.

In some aspects, the techniques described herein may relate to the centralized monitoring and control platform configured for real-time vehicle monitoring.

In some aspects, the techniques described herein may relate to the centralized monitoring and control platform configured for remote apparatus control.

In some aspects, the techniques described herein may relate to the centralized monitoring and control platform that may be configured for customizable alerts and/or notifications.

In some aspects, the techniques described herein may relate to the centralized monitoring and control platform that may be configured for geo-fencing.

In some aspects, the techniques described herein may relate to apparatus identification that may provide specific apparatus identification, recognition, tracking, and geofencing.

In some aspects, the techniques described herein may relate to geo-fencing that may support location-based features such as location tracking to monitor the apparatus as they enter or exits defined areas, triggering notifications and alerts based on movement across these boundaries, applications in location-based marketing to send promotions to owner/users nearby, security monitoring for detecting unauthorized access, unauthorized detection, and improving operational efficiency in logistics and transportation by tracking vehicle movements and optimizing routes. It may allow for geofencing capabilities to trigger notifications based on the apparatus/vehicle's location.

In some aspects, the techniques described herein may relate to the centralized monitoring and control platform that may be configured for firmware updates.

In some aspects, the techniques described herein may relate to a “Platform for Real-Time User Management,” which refers to a software system or framework designed to allow organizations to manage user-related functionalities in real time. This may include owner/user authentication, authorization, monitoring, and interaction with various systems and services.

In some aspects, the techniques described herein may relate to “Autonomy Time,” which generally refers to the duration the apparatus of the disclosure herein may operate independently without external assistance, supervision, or recharging. The autonomy time may be up to one hour, for example, 0.25, 0.5, 1, 2, 3, 4, 5, 6, 7, 8, 9, 10, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 minutes, and any combination thereof.

In some aspects, the techniques described herein may relate to any vehicle, such as one, two, three, four, five, six, seven, eight, none, ten wheels, and any combination thereof.

In some aspects, the techniques described herein may relate to vehicle adaptability, meaning that it may fit and be used with various motorcycles in the market.

In some aspects, the techniques described herein may relate to the apparatus and the system may be used for many apparatus such as, but not limited to, vehicles, doors, safe deposit boxes, etc., and any combination thereof.

In some aspects, the techniques described herein may relate to the apparatus that may be easily secured onto any vehicle and/or another apparatus that requires protection from theft by locking (referred to herein as an anti-theft device). However, installation and uninstallation of the apparatus may require special tool/s such that in the absence of these special tools, the apparatus may not be uninstalled for additional protection before, during, and/or after theft.

In some aspects, the techniques described herein may relate to that apparatus and may be used in one or more vehicle wheels, for example, the front, back, right side, and/or left side of a motorcycle wheel.

In some aspects, the techniques described herein may relate to that apparatus and may be used in one or more vehicle wheels with at least one wheel, for example, 1, 2, 3, 4, 5, 6, 7, 8, 9, 10, 11, 12, 13, 14, 15, 16, 17, 18, 19, 20, etc., wheels.

In some aspects, the techniques described herein may relate to the apparatus that may be configured to receive commands through a synchronized database compatible with multiple platforms, such as, but not limited to, cell phones, computers, smart watches, smart devices, etc., and any combination thereof. These commands may activate/inactivate the locking mechanism, which may prevent the rotation, for example, of a rim on which it may be installed due to an adaptation of the perforated tread lock. Thus providing theft protection for the vehicle. Thus, locking-unlocking the vehicle. For example, if a strap with perforations is attached to a rotating wheel, the moment a pin is inserted into the perforated strap, the wheel will stop rotating.

In some aspects, the techniques described herein may relate to multi-channel communication, which may support multiple communication methods for alerts, alarms, and notifications, including SMS.

In some aspects, the techniques described herein may relate to integration with GPS/GNSS units and systems. This integration may facilitate accurate location tracking. GPS location tracking enables real-time monitoring of the vehicle's location via GPS.

In some aspects, the techniques described herein may relate to a centralized monitoring and control platform to facilitate management and oversight of the apparatus.

In some aspects, the techniques described herein may relate to the apparatus having a GPS device that remains active during its blocking stage, ensuring its recovery in case it is stolen.

In some aspects, the techniques described herein may relate to the sensor proximity mechanism that may send an alert when the vehicle moves away from the owner/user and/or the customizable established range, for example, area, zone, pre-determined distance, etc., and/or any combination thereof. For example, the owner/user receives an alert when their vehicle is out of the location where they parked it.

In some aspects, the techniques described herein may relate to an encasing made of metal alloy or polymer with high resistance to shocks, dust, and water.

In some aspects, the techniques described herein may relate to the QR Code functionality that may enable easy setup and configuration through QR code scanning, simplifying the owner/user experience.

In some aspects, the techniques described herein may relate to violence recognition capabilities that utilize technology to recognize potential violence and/or threats regarding the apparatus or its surroundings.

In some aspects, the techniques described herein may relate to emergency contact alerts that may send notifications in real-time communication capabilities via one or more multi-channel communication in the apparatus.

In some aspects, the techniques described herein may relate to SMS and remote commands that may ensure immediate notifications and control.

In some aspects, the techniques described herein may relate to remote mechanical locking that may provide secure locking from a distance, enhancing owner/user confidence.

In some aspects, the techniques described herein may relate to the integrations and initiatives outlined, such as connecting with emergency services (911), collaborating with tax authorities like the Internal Revenue Service (IRS), and working with transportation agencies like the Department of Transportation (DOT). Enhancing communication with government bodies may improve public safety and service delivery.

In some aspects, the techniques described herein may relate to emergency alerts that may send notifications to designated contacts (in customizable lists) in critical situations. The designated contact may be up to 60, for example, 1, 2, 3, 4, 5, 6, 7, 8, 9, 10, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 contacts, and any combination thereof.

In some aspects, the techniques described herein may relate to the telecommunication capability that may have IoT units/devices with GSM connectivity and may enable communication and control over mobile networks. The IoT unit/device may be powered by an external and/or internal battery/batteries, offering flexibility in power sources for reliability.

In some aspects, the techniques described herein may relate to the Progressive Web Application (PWA) platform that may function effectively in limited connectivity conditions, making them usable even in areas with intermittent or slow connections. They may have fast loading times, improving owner/user experience by minimizing waiting periods and increasing retention rates. Additionally, by leveraging cache storage and other techniques, PWAs may significantly reduce data usage compared to traditional applications or websites. Users/owner may easily install a PWA on the apparatus without going through an app store, and the applications may be automatically updated in the background, ensuring that owner/users always have access to the latest version without any manual effort.

### Method for Activating the Vehicle Security Apparatus

A method is provided for activating a vehicle security apparatus for locking and unlocking vehicle wheels. The method includes:

### I. Locking the Vehicle Wheels:

Powering the servomotor via the battery.

Rotating the worm screw to drive the cylindrical container.

Moving the cylindrical container downward, pushing the pivot toward the perforated band.

Inserting the pivot into one of the perforated band holes when alignment occurs.

Compressing the spring to maintain pressure and retrying alignment if necessary.

Locking the perforated band to stop wheel movement.

### II. Unlocking the Vehicle Wheels:

Powering the servomotor to reverse the worm screw rotation.

Retracting the cylindrical container and pulling the pivot out of the perforated band.

Unlocking the perforated band and allowing wheel movement.

### III. Resetting the Apparatus for the Next Use:

Retracting the pivot and deactivating the servomotor and worm screw.

Preparing the apparatus for the next locking cycle.

In some embodiments, the electronic compartment allows remote locking/unlocking via a smart device. The system ensures security by preventing unauthorized wheel movement, detects tampering through onboard sensors, and notifies the user if pivot alignment fails.

In some embodiments, the method of the vehicle security apparatus prevents unauthorized movement of the vehicle's wheel when parked, protecting the vehicle from theft or tampering.

In some embodiments, the vehicle security apparatus enters a standby mode after completing the locking of the vehicle wheel/s, ensuring tamper detection through onboard sensors of the electronic compartment.

In some embodiments, the electronic compartment has sensors, which verify the alignment and locking of the pivot and notify the user of the non-alignment.

In some embodiments, the apparatus's electronic compartment locking and/or unlocking remotely via a smart device.

In some embodiments, the vehicle security apparatus prevents unauthorized movement of the vehicle's wheel when parked, protecting the vehicle from theft or tampering.

In some embodiments, the vehicle security apparatus enters a standby mode after completing the locking of the vehicle wheel/s, ensuring tamper detection through onboard sensors of the electronic compartment.

In some embodiments, the electronic compartment has sensors, wherein the sensors verify the alignment and locking of the pivot and notify the user of the non-alignment.

In some embodiments, the owner/user activates the locking mechanism that prevents his motorcycle move forward or backward the moment you reach your destination, thanks to a multiplatform application that has synchronized information from the owner/user and his motorcycle in a database, which can be accessed from a computer, which can be installed on your cell phone or configured in a remote device, when issuing the motherboard lock command configured on the apparatus activates its operation, which consists of the rotation of a servomotor powered by a long-lasting battery, this rotates an worm screw that has adapted, this screw in turn has adapted in its lower part a cylindrical container with internal thread, which makes it be activated, the container slides down by pushing a pivot that embed in the perforated band that is installed in the rim of the tire, producing the blocking of its rotation and at the same time of the ring in which it is installed, if the pivot does not fall directly into one of the perforated band perforations, the spring helps you keep the pressure for when the belt rotates forward or backward at which time the spring pushes the pivot and locking takes place. Likewise, to deactivate it, the signal must be sent unlocking, which makes the servomotor and the worm screw rotate in the opposite direction, making the container with internal thread rise, freeing the rim of the blockade.

In some embodiments, the apparatus activates when the motorcycle is parked, locking it to prevent theft. It subsequently enters a standby mode until it receives a deactivation signal that unlocks the motorcycle. Nevertheless, the onboard sensors remain operational to provide the owner/user with information should someone attempt to move or tamper with the vehicle for realtime, near time, short-term, long-term, etc., tamper detection.

### Example 1

The Housing [19] has a Clamp [22] that fits on the motorcycle shock absorber and/or suspension system at a millimeter distance so that at the moment of activation of the blocking system [11], the Pivot [18] can enter the perforated band [20]. This casing is manufactured in a metal alloy or a high shock resistance, shockproof polymer water and dust. The Housing [19] fits the Clamp [22] thanks to screws internals and has a lid that protects the components inside.

The Servomotor [12] has an adapted Worm Screw [13] that is located screwed to a cylindrical container with internal thread [15]. The worm screw [13] rotates thanks to the revolutions of the servomotor [19], which is powered by a long-lasting battery located in the battery compartment battery and motherboard [21]. The servomotor [19] is fixed to the Housing [19], making it which causes the cylindrical Container to slide and retract at the moment when the Locking System [11] is activated and deactivated.

The cylindrical container with internal thread [15] is responsible for sliding downwards, thanks to the function of the Servomotor [12] and the Auger [13], so that the Pivot [18] is inserted into the perforated Band [20] so that it locks the rim and vice versa to unlock. The Apparatus in its locking system [11], with a servomotor [12], which has adapted an Auger [13] that is screwed to a cylindrical Container with internal thread [15], It also has a Spring [16]this spring fulfills the function of creating a restore or regain pressure in case the Pivot [18], and do not fall into one of the holes of the Drilling Band [20], retains the pressure of the Pivot [18] until the appropriate moment is provoked of the wheel rotation lock.

The Pivot [18] is created of highly resistant material capable of supporting the acceleration force of the motorcycle preventing it from moving forward or backward, since it is responsible for blocking the rotating movement of the Band perforated [20], during that process if the Pivot [18] does not fall directly inside one of the holes of the perforated Band [20] it stops and accumulates its pressure in the Spring [16].

The perforated band [20] has multiple holes around its circumference, which have an inclination towards the interior to that the Pivot [18] has a greater margin of sliding towards the inside of its perforations, it is installed on the rim of the motorcycle, so it rotates along with the tire, this band is placed just below the Pivot [18] so that when the lock is activated, it occurs effective way.

The Locking System [11] also has a latch [14] that prevents the Pivot [18] rises more than necessary at the moment it is deactivated and a design in its own structure that limits it when it is activated.

In the battery and motherboard compartment [21] are the components that are responsible for controlling and keeping energized the apparatus, the motherboard has an Internet connection, a sensor proximity, Bluetooth, infrared, Gyroscope, WIFI, GPS, GSM, MMS and SMS with which you are able to block, unlock, monitor and manage the recovery of the motorcycle.

In the conducted tests, the apparatus responded effectively to the activation and deactivation of the locking mechanism, as well as to its geolocation. It also performed well in resistance tests involving various manufacturing materials.

### Additional Mechanical Components and Fasteners for Secure Assembly:

| Description | Material | Qty |
|---|---|---|
| O-Ring-Loaded U-Cup Seal | Buna-N Rubber Durometer | 1 |
| | 90A (Hard) | |
| Brass Tapered Heat-Set | Brass | 11 |
| Inserts for Plastic | | |
| Shoulder Screw | Alloy Steel, Black Oxide | 1 |
| M6 × 40 Screws | Zinc-Plated Alloy Steel | 5 |
| Tamper-Resistant Drilled | 18-8 Stainless Steel | 3 |
| Spanner Pan Head | | |
| Screws | | |
| Compression Spring | Stainless Steel - Compression | 1 |
| M6 × 12 Screw (Allen Head) | 18-8 Stainless Steel | 3 |
| M6 × 12 Screw (Hexagonal Head) | 18-8 Stainless Steel | 3 |
| Flat-Head Set Screw M2 × 3 | 18-8 Stainless Steel | 1 |
| M3 × 12 Screw | 18-8 Stainless Steel | 2 |
| Magnet 4 × 4 mm | Neodymium | 1 |
| Sealing Rubber Gasket | EPDM Rubber 60 SHORE A | 1 |

### DETAILED DESCRIPTION OF THE FIGURES

All components have a tolerances unless otherwise specified; for decimals: of X±1.01 .XX±0.005 .XXX±0.0005 .XXXX±0.00005 (inches) X±13 X.X±0.3 X.XX±0.13 X.XXX±0.013. In this example, the 304/304L Stainless Steel may be used to make parts like the locking shaft, worm screw, and safety pin is known for its corrosion resistance, strength, and machinability. In some embodiments, the steel may be combined with and/or replaced by Titanium (Grade 5/Ti-6Al-4V), Carbon Steel (1045 or 4140 Alloy Steel), Aluminum (7075 or 6061-T6), Brass (C360 or C464 Naval Brass). Polymer-Based Composite (PEEK—Polyether Ether Ketone), and/or any combination thereof.

Some components, such as the Main Housing, Fork Grip, and Crown, may be made of molded ABS (Acrylonitrile Butadiene Styrene), ABS reinforced with or without fiberglass, Polycarbonate (PC) Reinforced with/without Fiberglass, Nylon (PA6 or PA66) with/without Fiberglass Reinforcement, Glass-Filled Polypropylene (GF-PP), Acetal (POM—Polyoxymethylene) with Fiberglass, Carbon Fiber Reinforced Polymer (CFRP), Ultem (Polyetherimide—PEI) Reinforced with Fiberglass, and/or any combination thereof.

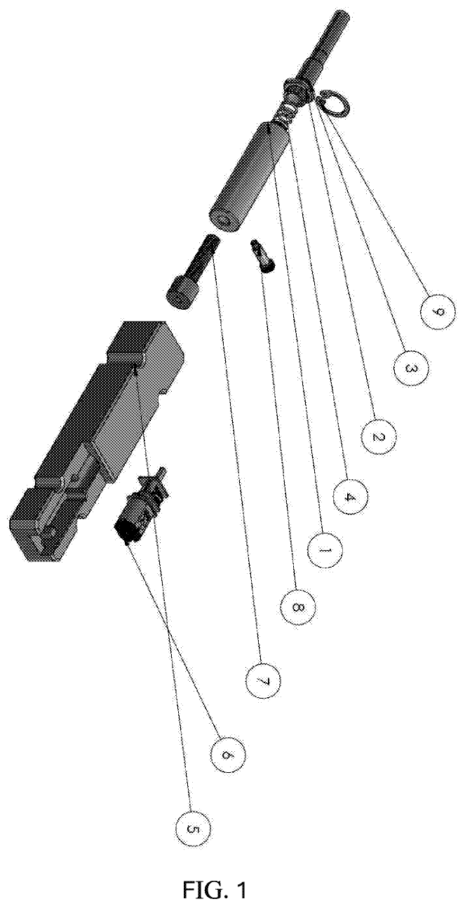

FIG. 1. shows a side view of the apparatus and its internal mechanism. Shown here is a locking shaft. The primary component forms the central axis of the locking mechanism [1], which is made of stainless steel 304.304L. The end Nut secures the assembly, likely at one terminal end [2], which is made of stainless steel 304.304L. A locking pin and/or pivot is used to secure components in place, potentially removable [3] and made of stainless steel 304.304L. Compression Spring provides tension or resistance within the mechanism [4], which is made of stainless steel, and the Spring Force is 12.6 N. The Main Casing is the outer shell, enclosing the internal components [5], which is made of molded ABS reinforced with FG. The gear motor (micro-metal-gearmotor) drives the movement of the locking mechanism [6]. Threaded Rod facilitates movement or adjustment, likely engaging with the motor [7], which is made of stainless steel. Short-Thread Alloy Steel Shoulder Screw Fastener for precise positioning [8]. Internal Retaining Ring secures components in grooves or on shafts [9].

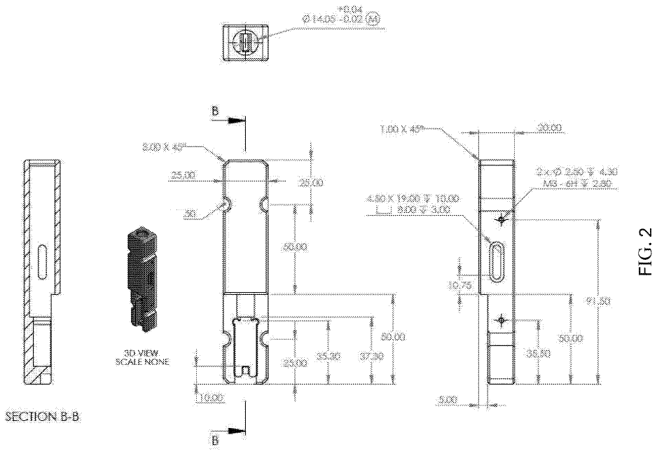

FIG. 2. Technical Drawing of a Linear Locking Component. This technical drawing provides detailed specifications for a linear locking component designated as the main casing. The drawing features various views, including a detailed section view (Section B-B) that highlights the component's internal profile and dimensions. The precise measurements and tolerance indications are crucial for ensuring proper fit and function within mechanical systems. The drawing outlines specific features, such as grooves or notches, that may interact with other components for secure locking. A 3D view in the drawing aids in visualizing the component's geometry. This linear locking component is designed for applications requiring secure and reliable locking mechanisms in various industrial settings. System Measurement Data: The distance between the device and the crown is up to 15 mm, for example, 1, 2, 3, 4, 5, 6, 7, 8, 9, 10, 11, 12, 13, 14, 15 mm.

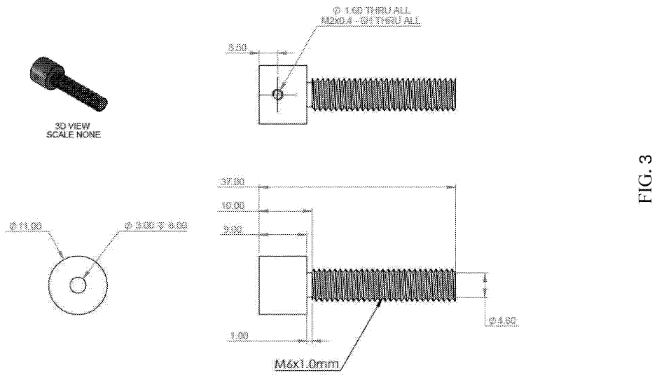

FIG. 3. Drawing of a Threaded Fastener. This technical drawing depicts a threaded fastener designated as a Threaded Rod. The drawing includes top and side views, showcasing the fastener's geometry and detailed dimensions. The threaded section is clearly marked, indicating the pitch and diameter necessary for proper integration with corresponding components. This threaded fastener is integral to creating secure connections in mechanical assemblies, enhancing reliability and performance in industrial contexts.

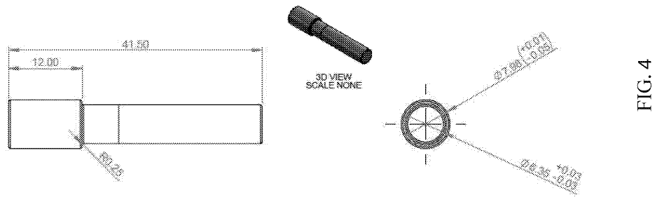

FIG. 4. Technical Drawing of a Locking pin and/or pivot. This technical drawing illustrates a locking pin and/or pivot. The drawing features a simplified design with a top view and side view, highlighting the pin's essential dimensions and tolerances. Specific measurements are provided, detailing the overall length and diameter of the pin, which is crucial for ensuring proper fit within mechanical assemblies. The locking pin and/or pivot is designed to secure components in place, preventing unintended movement and enhancing the reliability of mechanisms. This locking pin and/or pivot serves as an essential component in mechanical systems, providing a reliable method for securing parts and ensuring the integrity of assemblies. The pin length in the locked state is 13 mm.

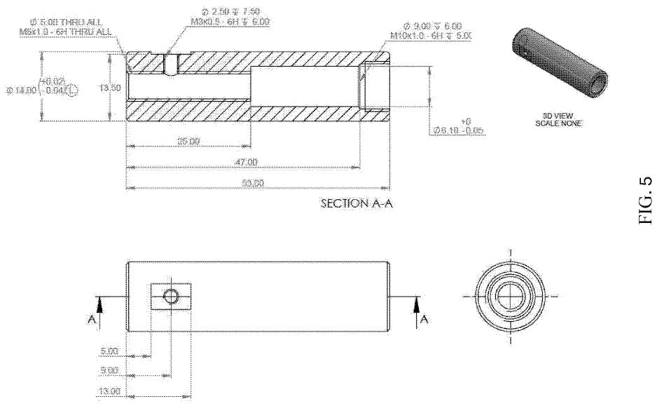

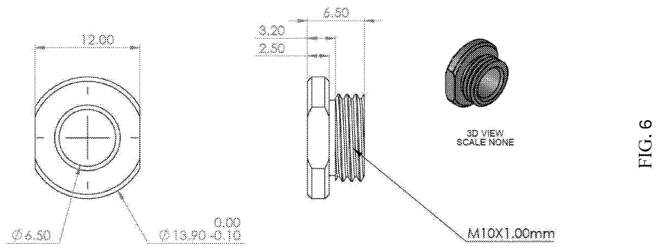

FIG. 5. Drawing of a Locking Shaft. This technical drawing presents a locking shaft, which is designated as a locking shaft. The drawing includes various views, such as the side view and a cross-sectional view (Section A-A), providing detailed insights into the shaft's design and dimensions. Precise measurements indicate the overall length, width, and critical features essential for proper functioning within the locking mechanism. The cross-section highlights internal features or profiles that may be essential for the locking functionality, ensuring alignment with corresponding components. Notes may specify the materials used for the shaft, ensuring strength and durability in operational conditions. This locking shaft is crucial for the operation of locking mechanisms, providing a central component that enables secure engagement and disengagement in mechanical assemblies.

FIG. 6. Drawing of a Locking Coupling. This technical drawing illustrates a locking coupling designated as an End Nut. The drawing features a front view and a side view, providing essential dimensions and details about the component's design. Specific measurements, including diameter and height, are clearly marked, allowing for accurate fabrication and integration within the locking mechanism. The side view showcases the profile of the locking coupling, indicating features that may interact with other components for secure engagement. This locking coupling is a vital component in securing connections within mechanical assemblies, enhancing the overall reliability and effectiveness of the locking system.

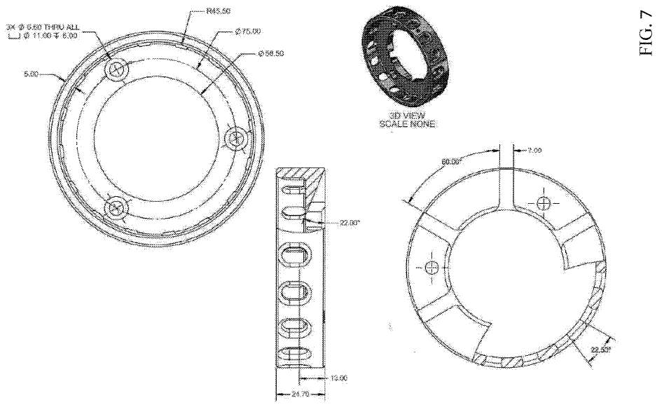

FIG. 7. Technical Drawing of a perforated band of Locking Mechanism. This drawing illustrates a perforated band or the circular locking mechanism designed for secure fitting in various applications. The drawing features detailed views, including the front and side perspectives, showcasing precise dimensions and tolerances to ensure proper alignment and functionality. Key elements include a central bore for mounting, multiple fastening points (holes), and a unique profile designed to engage with complementary components. This locking mechanism is integral to enhancing security in mechanical assemblies, making it suitable for various industrial applications. This is made of molded ABS reinforced with FG.

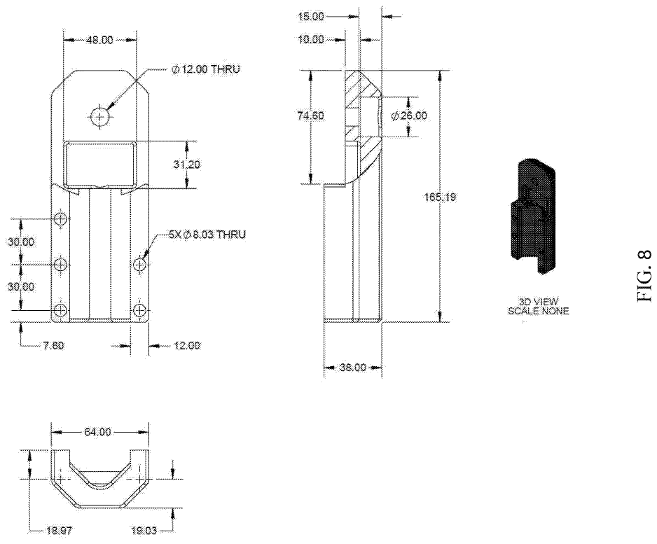

FIG. 8. Drawing of a Locking Arm. This technical drawing showcases a locking arm. The drawing includes front, side, and top views, providing detailed dimensions and structural features essential for the component's functionality. Precise measurements for length, width, and height are clearly indicated, ensuring accurate manufacturing specifications. The drawing illustrates the locking arm's profile, including features such as cutouts or mounting points that facilitate secure engagement with other components in the locking mechanism. This locking arm is integral to the locking mechanism, enhancing the security and effectiveness of the system by providing a reliable means of engagement and disengagement within mechanical assemblies. It is made of molded ABS reinforced with FG.

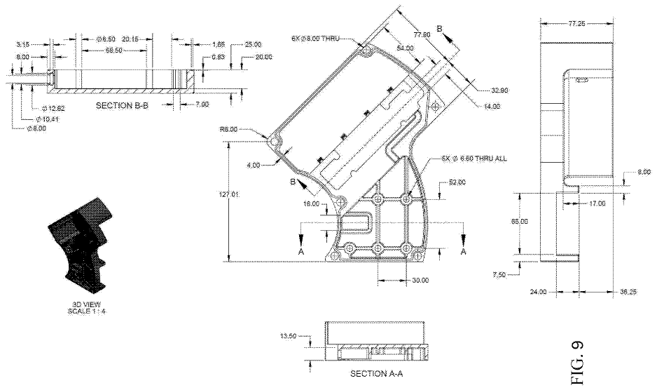

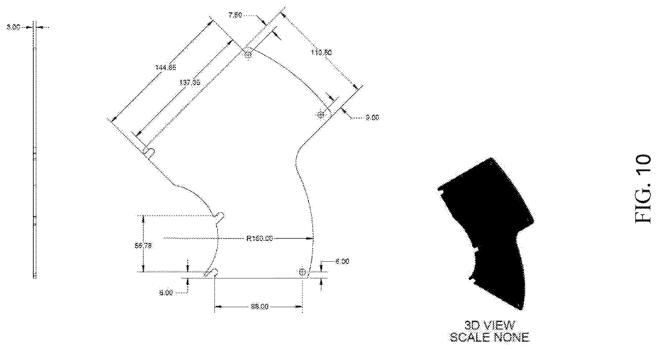

FIG. 9. Main Body Technical Drawing. This is a detailed technical drawing of a mechanical part of the Main Body. Orthographic views: Top, front, and sectional views labeled SECTION A-A and SECTION B-B, illustrating cross-sectional details. Linear measurements (in millimeters) for lengths, diameters, and spacing, including tolerances for precise manufacturing. Key design elements such as holes, in this example, there are six (6X) holes, each with a diameter of 6.80 mm (06.80), that are to be drilled all the way through the part. (6X Ø6.80 THRU), rounded edges (R6.00), wall thickness, and drafts for manufacturability. A shaded isometric view (bottom-right) provides a three-dimensional perspective of the part. The dimension of the sliders is 13 mm×8 mm. It is made of molded ABS reinforced with FG.

FIG. 10. Profile View of Main Body Component. This is a technical drawing of a mechanical component with a profile view and critical dimensions for manufacturing precision. A detailed side-view outline with radii, straight segments, and curves clearly dimensioned. Measurements for lengths, radii (R150.00), and hole placements (6.00, 9.00 mm). Angular relationships and key spacings, such as 88.00 mm width and 56.78 mm height offsets. A small shaded isometric view (bottom-right corner) provides a three-dimensional perspective.

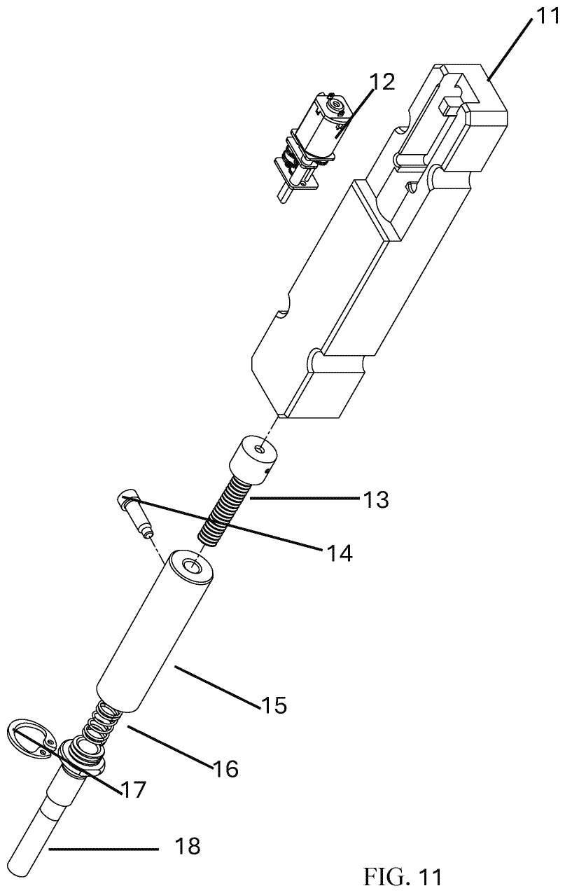

FIG. 11. displays the Locking System with various components. The system here is installed on a motorcycle wheel. The locking mechanism has several key elements: Servomotor [12]: The motor that drives the mechanism, enabling the rotation of the worm screw. Worm Screw [13]: The worm screw that transmits the servomotor's rotational movement to the cylindrical container. Cylindrical Container with Internal Thread [15]: The threaded cylindrical container that moves vertically to extend or retract the pivot. Spring [16]: The compressed spring that keeps the pivot extended until it aligns with a hole in the perforated band. Pivot [18]: The movable element that blocks the wheel's rotation when inserted into the perforated band. Latch [14]: The latch that limits excessive movement of the pivot and other components during activation and deactivation. Blocking System [11]: The system that allows the pivot to engage with one of the perforated band's holes.

Blocking System [11], the main locking system that enables interaction between the Pivot [18] and the Perforated Band, immobilizing the wheel. [12] The servomotor is an electric motor housed within the casing, responsible for generating the necessary motion to activate the mechanism. [13] Worm Screw is a screw mechanism that transmits the servomotor's rotation into linear motion. [15] Cylindrical Container with Internal Thread is a threaded cylindrical component that moves vertically when driven by the worm screw, pushing the Pivot [18] forward. [16] Spring is a compressed spring that keeps the pivot extended until it aligns with a hole in the Perforated Band. [18]A pivot is a movable element that is inserted into the perforated band to lock the wheel. [14]A latch is a safety lock that limits excessive movement of the pivot and other components to prevent malfunctions. The system is mounted on the wheel axle, with the perforated band rotating in sync with the tire. The figure shows the pivot in its extended position, ready to engage with a hole and secure the motorcycle in place.

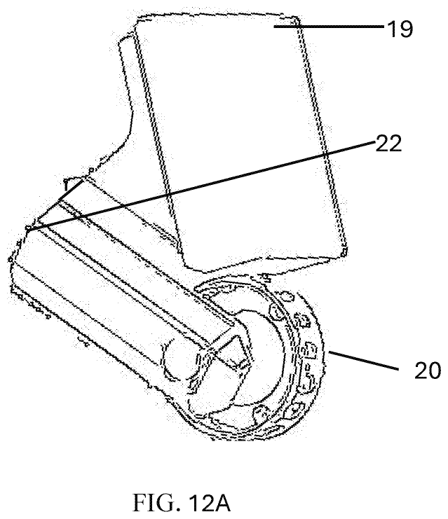

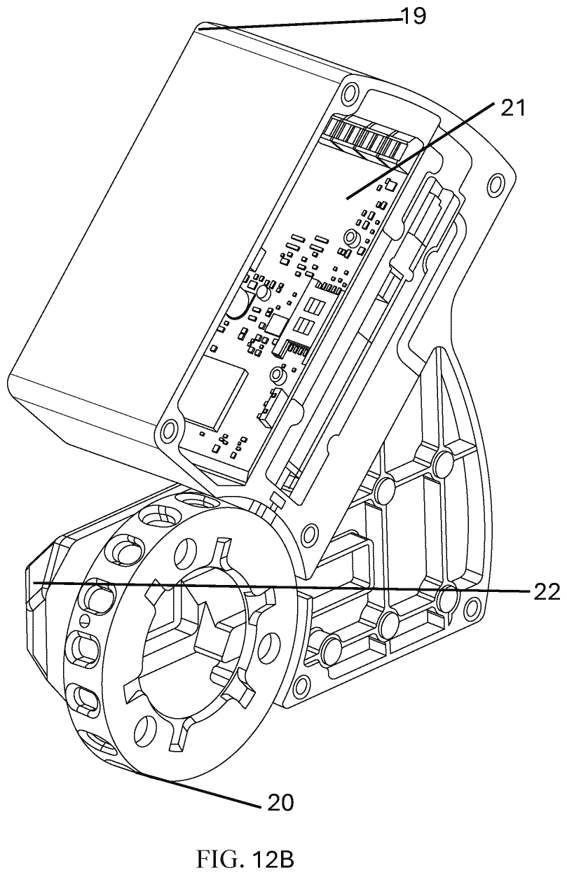

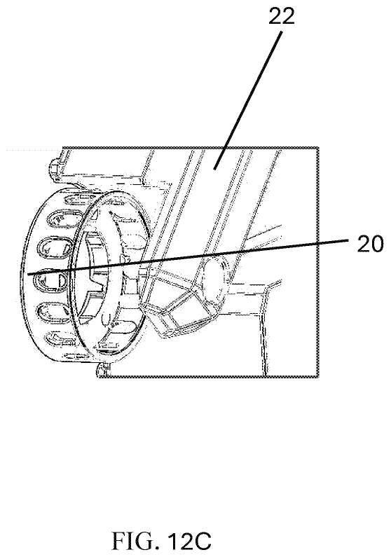

FIG. 12. depicts the Locking System installed with a wheel. The electronics are covered in FIG. 12 A and uncovered 12B. FIG. 12C depicts a closer view of the perforated band and the clamp.

FIG. 12A illustrates the vehicle security apparatus installed on a vehicle wheel. It shows the housing [19] enclosing the electronic compartment, thus protecting internal components from environmental exposure. The perforated band [20] is partially visible and aligned with the pivot mechanism.

FIG. 12B presents the same installation as in FIG. 12A but with the electronic compartment [21] exposed. This exposes internal components such as the servomotor [12] and the cylindrical container [15] that drive the locking mechanism. The perforated band (20) remains visible, demonstrating its alignment with the pivot [18].

FIG. 12C provides a detailed close-up of the perforated band [20] and the clamp [22] securing the apparatus to the vehicle shock absorber and/or suspension system. This view highlights the precision alignment required for the pivot [18] to engage with the perforated band during the locking process.

The wheel may be of a motorcycle, car, truck, motorized bicycle, etc. The figures highlight the following key components:

Housing [19] is the main casing that encloses all system components made from impact-resistant, waterproof, and dustproof material. Blocking System [11] is the locking mechanism that enables interaction between the Pivot and the Perforated Band, immobilizing the wheel. The system allows the pivot to engage with one of the perforated band's holes. The battery and motherboard compartment [21] is the compartment housing the rechargeable battery, and the motherboard is responsible for controlling and powering the system. A clamp [22] is a sturdy clamp that secures the Housing [19] to the motorcycle's shock absorber and/or suspension system, ensuring stability and precise alignment. Perforated Band [20] is a metal band with strategically placed perforations around the wheel axle, which interacts with the pivot to lock the wheel. This band rotates with the wheel and allows the Pivot to engage when the system is activated. Battery and Motherboard Compartment [21]: The compartment that houses the battery and motherboard is responsible for powering and controlling the apparatus.

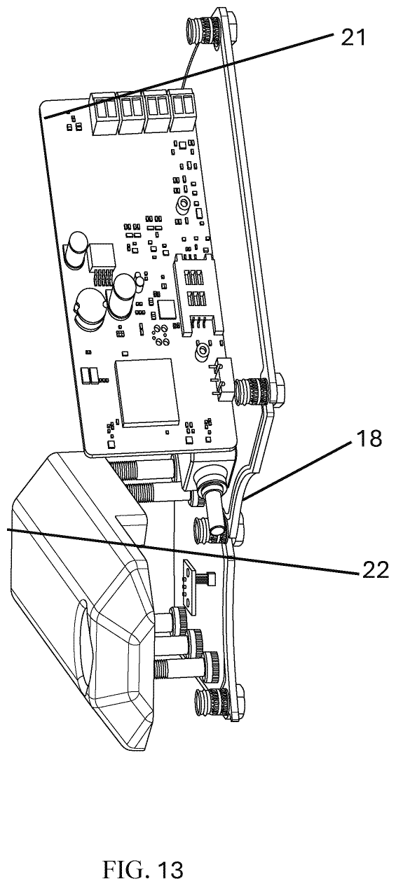

FIG. 13 shows the locking system firmly attached to the motorcycle via the clamp, with the perforated band aligned for effective operation.

The figure displays the Locking System installed on an automobile, such as a motorcycle. The locking system is firmly attached to the motorcycle via the clamp, with the perforated band aligned for effective operation. The Locking System focuses on the following key components:

The battery and motherboard compartment [21] contains the rechargeable battery and motherboard, which control and power the locking system. This compartment ensures seamless connectivity and operation via various communication technologies. A clamp [22] is a robust clamp that secures the locking system's housing to the motorcycle's shock absorber and/or suspension system, maintaining a stable and precise positioning for proper engagement. The clam secures housing to the motorcycle shock absorber and/or suspension system [22]. Pivot [18] is the movable locking element that extends outward to engage with the Perforated Band, preventing the wheel from rotating when the system is activated. The pivot [18] is shown herein in its extended position.

In the figure, the battery compartment is housed within the main casing, the clamp is firmly attached to the motorcycle, and the pivot is shown in its extended position, ready to lock the wheel.

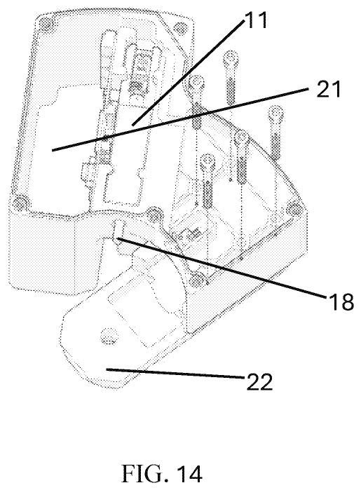

FIG. 14. showcases the Locking System mounted on an automobile such as a motorcycle, emphasizing the following key components:

Housing [19] is the main protective casing that encloses all internal components and is designed to withstand impact, water, and dust exposure. Battery and Motherboard Compartment [21] is the section inside the housing that contains the rechargeable battery, and the motherboard is responsible for powering and controlling the locking mechanism. Blocking System [11] is the core mechanism that activates the Pivot [18] to engage with the Perforated Band, securing the wheel in place. Pivot [18] is the movable locking element that extends outward to insert into a perforation on the band, preventing wheel rotation. A clamp [22] is a strong attachment mechanism that secures the housing to the motorcycle's shock absorber and/or suspension system, ensuring proper alignment and functionality.

In the figure, the locking system is firmly mounted, with the housing encasing the electronic and mechanical components, the clamp ensuring stability, and the pivot in its extended position, ready to engage the locking system.

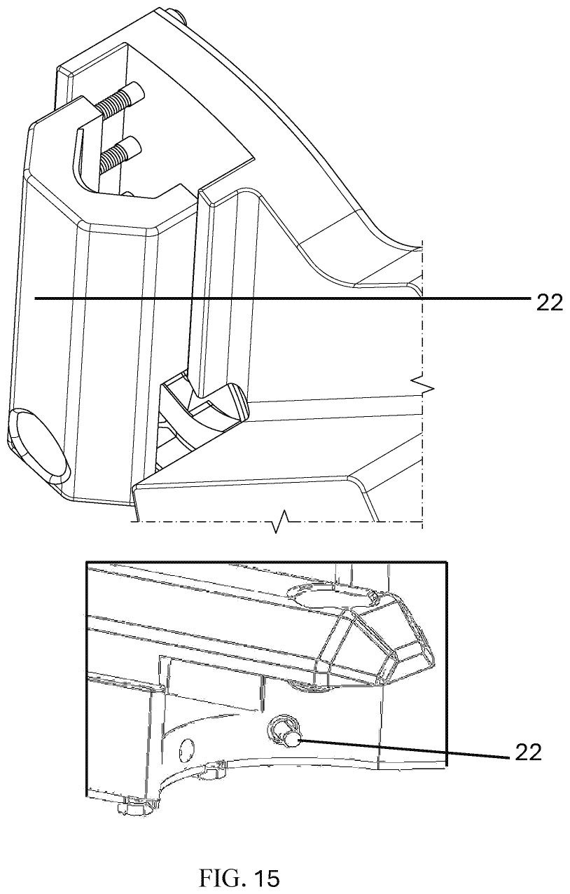

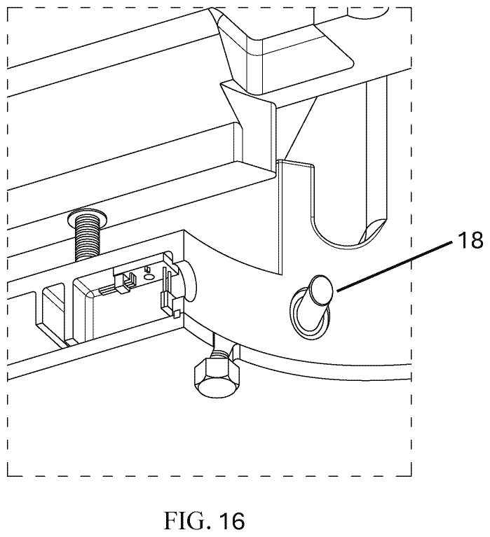

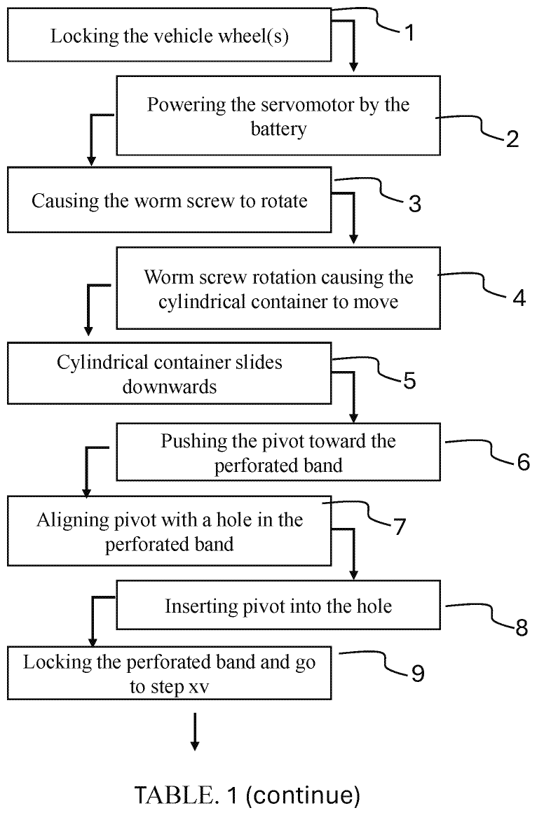

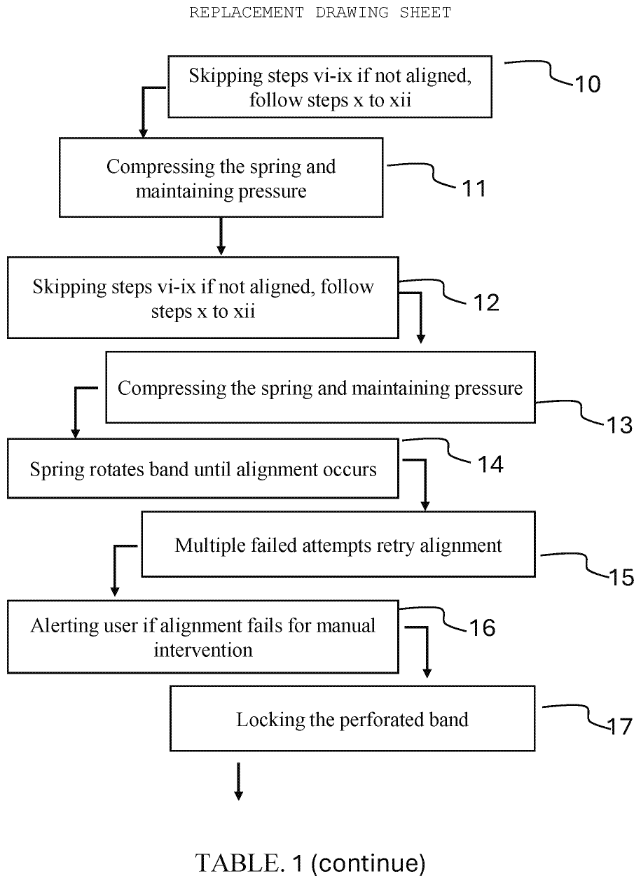

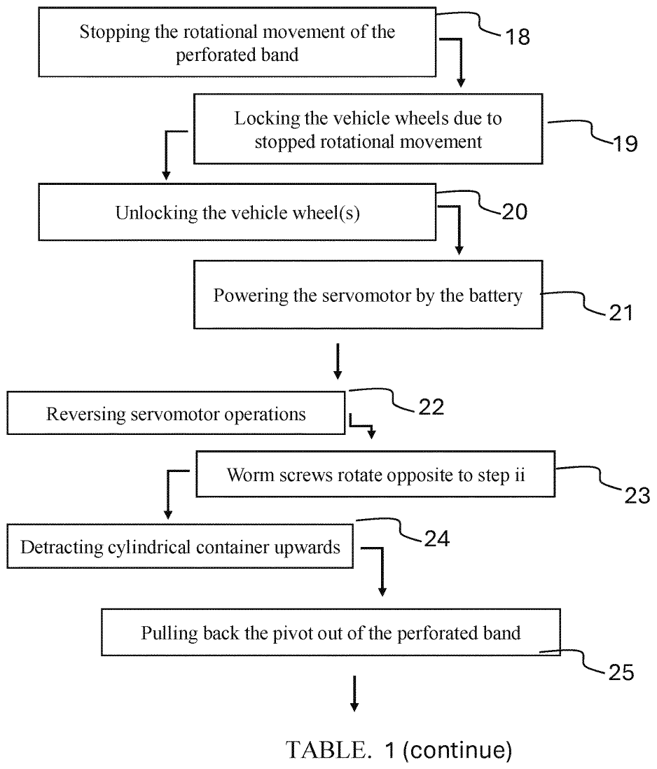

FIG. 15. Shows the Clamp. It focuses on the Clamp [22], which attaches the housing to the motorcycle's shock absorber and/or suspension system. The essential component secures the locking system to the motorcycle's shock absorber and/or suspension system. The clamp is designed for maximum firmness, ensuring the Locking System remains stable even under vibrations and external forces. It is constructed from a high-strength metal alloy, providing durability and resistance to environmental conditions such as water, dust, and mechanical stress. An internal screw mechanism allows for precise tightening, guaranteeing a millimetric fit between the clamp and the shock absorber and/or suspension system. This ensures that the locking system remains securely in place, preventing unwanted movement and maintaining the correct alignment for the Pivot [18] to engage effectively with the Perforated Band.

Additionally, the only way to unscrew the clamp is by opening the apparatus, which requires a special screwdriver. This process takes time and demands specialized tools, making it highly impractical for thieves. Since motorcycle thefts rely on speed and efficiency, attempting to remove the Locking System would be too time-consuming, significantly reducing the likelihood of theft. Removing the motorcycle's wheel is necessary for this installation to properly position and secure the clamp and Perforated Band. This adds an extra layer of security, as thieves would not only need the special tool but also go through the complex process of dismantling the wheel, making quick theft virtually impossible.

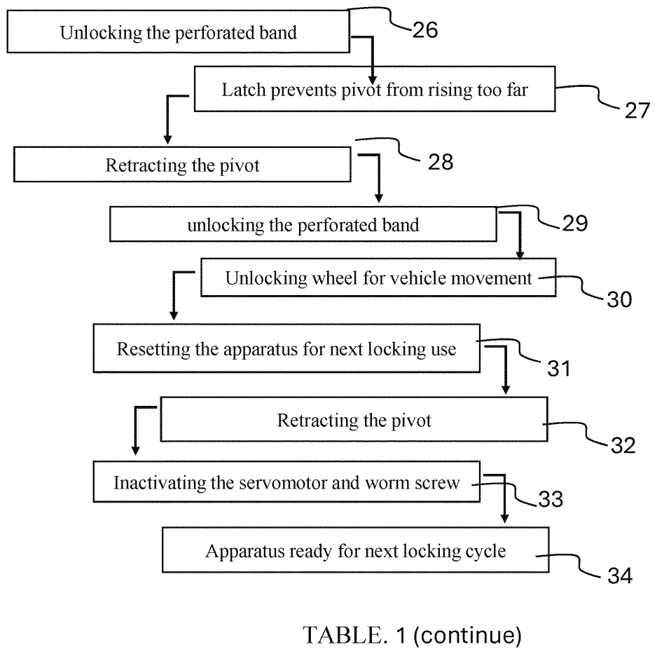

FIG. 16. This focuses on the Pivot [18], an essential and robust component of the Locking System. The Pivot [18] is designed to be extremely strong to withstand the force exerted by the motorcycle during normal operation. Made from high-strength, durable materials, it is engineered to securely lock the wheel in place when activated, ensuring the motorcycle stays immobile. The Pivot [18] is positioned to extend into the Perforated Band [20] when the system is triggered, preventing the wheel from rotating. Its strength allows it to resist the forces of movement, protecting the motorcycle from rolling while it is parked or when security is activated. Infrared sensor/s ensure activation only when the vehicle is fully stopped.

One of the key features of the Pivot is its activation mechanism: it can only be engaged when the motorcycle is completely stopped. This is thanks to the advanced technology integrated into the system, including infrared sensors that detect the motorcycle's movement. These sensors ensure that the Pivot [18] remains retracted while the motorcycle is in motion, preventing any potential accidents or damage. The apparatus automatically engages only when the motorcycle is at a full stop, providing safe and secure locking without interfering with the motorcycle's operation. This intelligent safety feature makes the Pivot a critical part of the system, as it ensures that the locking mechanism is only active when it is safe to do so.

Table. 1. A Method for activating a vehicle security apparatus for locking and unlocking the vehicle, wherein the vehicle security apparatus includes: a housing encasing, a servomotor, a worm screw, a cylindrical container with an internal thread, a pivot, a perforated band, a compression spring, screw/s or bolts, a latch, a clamp, a blocking system, and an electronic compartment further including a battery and a motherboard; the steps including: Locking the vehicle wheel/s [1], powering the servomotor by the battery [2], causing the worm screw to rotate [3], the worm screw rotation causing the cylindrical container to move [4], causing the cylindrical container to slide downwards [5], pushing the pivot toward the perforated band [6], when aligning the pivot with one of the holes in the perforated band [7], inserting the pivot into the hole [8], and locking the perforated band and go step xv [9], skipping steps vi-ix when the pivot does not align with a hole in the perforated band, and following steps x to xii [10], compressing the spring and maintaining pressure [12], ensuring the spring continues rotating the band until the pivot aligning occurs [13], aligning multiple failed attempts [14], the apparatus retries until the aligning of step xi occurs [15], alerting the user for manual intervention if the aligning of step xi does not occur [16], locking the perforated band [17], stopping the rotational movement of the perforated band [18], locking of the vehicle wheels due to stopped rotational movement of the perforated band [19], unlocking the vehicle wheel/s [20]: powering the servomotor by the battery [21], reversing servomotor operations [22], the worm screws rotating in the opposite direction of the step ii [23], detracting the cylindrical container upwards [24], pulling back the pivot out of the perforated band [25], unlocking the perforated band [26], the latch ensuring that the pivot does not rise beyond its intended position [27], retracting the pivot [28], unlocking the perforated band [29], unlocking the wheel to move the vehicle [30], resetting the apparatus for next locking use [31]: retracting the pivot [32], inactivating the servomotor and worm screw [33], readying the apparatus for the next locking cycle[34].

It is to be understood that the above description is intended to be illustrative and not restrictive. For example, the above-described embodiments (and/or aspects thereof) may be used in combination with each other. In addition, many modifications may be made to adapt a particular situation, method, system apparatus, or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any apparatus or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claim.

1. A vehicle security apparatus comprising: a housing encasing, a servomotor, a worm screw, a cylindrical container, a movable pivot, a perforated band, a compression spring, one or more internal screws, a latch, a clamp, a blocking system, and an electronic compartment, and the vehicle comprises at least one wheels with rim and vehicle shock absorber; wherein the electronic compartment further comprising of a battery and a motherboard, wherein the housing encasing is mounted to the clamp by one or more internal screws, wherein the clamp is secured with precise alignment within up to 100 mm to the vehicle shock absorber, wherein the perforated band comprises of up to 50 holes, wherein the perforated band is fixed to the vehicle wheel rim, wherein the servomotor is fixed within the housing encasing and is connected to the battery, wherein the worm screw is connected to the servomotor, wherein the worm screw is connected to the cylindrical container, wherein the worm screw is configured to enable the pivot's movement, wherein the pivot movement engages with the cylindrical container with internal threading, and wherein the apparatus is configured to lock and unlock vehicle wheels.

2. The vehicle security apparatus of claim 1, wherein the housing encasing protects from environmental elements the servomotor, the worm screw, the cylindrical container, the pivot, the perforated band, the compression spring, —the latch, a locking system, and the electronic compartment; and wherein the housing encasing is made of high-strength polymer.

3. The vehicle security apparatus of claim 1, wherein the precise alignment allows the pivot movement to engage with the one hole of the perforated band when locking is activated and wherein the engagement is configured to lock vehicle wheels.

4. The vehicle security apparatus of claim 1, wherein the latch regulates pivot movement during locking and unlocking.

5. The vehicle security apparatus of claim 1, wherein the compression spring is located alongside the pivot and is configured to maintain a tension of 12.6 N.

6. The vehicle security apparatus of claim 1, wherein the internal screws secure the overall assembly, wherein the latch is positioned to limit the upward movement of 5 to 7 mm for the pivot and is configured as a mechanical stop.

7. The vehicle security apparatus of claim 1, wherein the battery connects to the servomotor and the cylindrical container through fastening screws.

8. The vehicle security apparatus of claim 1, wherein the motherboard comprises a remote interface with the servomotor, wherein the remote interface is configured to lock and unlock the vehicle remotely.

9. The vehicle security apparatus of claim 1, wherein the apparatus further comprises Real-Time Operating System (RTOS) wherein the RTOS connects with the servomotor, worm screw, cylindrical container, pivot, perforated band, compression spring, latch, and electronic compartment, wherein the RTOS enables coordinated operation of the locking mechanism.

10. The vehicle security apparatus of claim 1, wherein the electronic compartment further comprises one or more selected from a group consisting of RTOS, proximity sensors, motion sensors, tilt sensors, Bluetooth, GPS, GSM, WiFi, IoT, SMS/MMS communication modules, and any combination thereof.

11. The vehicle security apparatus of claim 10, wherein the electronic compartment is configured to send customizable alerts, notifications, and/or alarms.

12. The vehicle security apparatus of claim 10, wherein the electronic compartment is configured for real-time location tracking.

13. The vehicle security apparatus of claim 10, wherein the electronic compartment is configured for real-time geofencing.

14. The vehicle security apparatus of claim 10, wherein the electronic compartment is adapted to recover the vehicle.

15. The vehicle security apparatus of claim 10, wherein the electronic compartment is adapted for the vehicle's real-time monitoring and control.

16. The vehicle security apparatus of claim 1, wherein the electronic compartment further comprises a user management module, wherein the user management module secures the apparatus authentication, registration, access control, remote functionality, real-time notifications, and user-customizable settings.

17. The vehicle security apparatus of claim 16, wherein the user management module is configured to be used by one or more users in real time.

18. The vehicle security apparatus of claim 1, wherein the electronic compartment further comprises a centralized monitoring and control platform.

19. The vehicle security apparatus of claim 18, wherein the centralized monitoring and control platform is configured for real-time vehicle monitoring.

20. The vehicle security apparatus of claim 18, wherein the centralized monitoring and control platform is configured for remote control of the apparatus.

21. The vehicle security apparatus of claim 18, wherein the centralized monitoring and control platform is configured for customizable alerts and/or notifications.

22. The vehicle security apparatus of claim 18, wherein the centralized monitoring and control platform is configured for geo-fencing.

23. The vehicle security apparatus of claim 18, wherein the centralized monitoring and control platform is configured for firmware updates.

24. A Method for activating a vehicle security apparatus for locking and unlocking a vehicle wheel/s, wherein the vehicle security apparatus comprises: a housing encasing, a servomotor, a worm screw, a cylindrical container with an internal thread, a pivot, a perforated band with up to 50 holes, a compression spring, screw/s or bolts, a latch, a clamp, a blocking system, and an electronic compartment further comprising of a battery and a motherboard,
wherein the method comprising:
I Locking the vehicle wheel/s:
i. powering the servomotor by the battery,
ii. causing the worm screw to rotate,
iii. rotating the worm screw causes the cylindrical container to move,
iv. causing the cylindrical container to slide downwards,
v. pushing the pivot toward the perforated band,
vi. when aligning the pivot with one of the holes in the perforated band,
vii. inserting the pivot into the hole, and
viii. locking the perforated band and go step xv,
ix. skipping steps vi-ix when the pivot does not align with a hole in the perforated band, and following steps x to xii,
x. compressing the spring and maintaining pressure,
xi. ensuring the spring continues rotating the band until the pivot aligning occurs,
xii. aligning multiple failed attempts, the apparatus retries until the aligning of step xi occurs
xiii. alerting the vehicle-owner for manual intervention if the aligning of step xi does not occur,
xiv. locking the perforated band,
xv. stopping the rotational movement of the perforated band,
xvi. locking of the vehicle wheels due to stopped rotational movement of the perforated band,
II unlocking the vehicle wheel/s:
xvii. powering the servomotor by the battery,
xviii. reversing servomotor operations,
xix. the worm screws rotating in the opposite direction of the step ii,
xx. detracting the cylindrical container upwards,
xxi. pulling back the pivot out of the perforated band,
xxii. unlocking the perforated band,
xxiii. the latch ensuring that the pivot does not rise beyond its intended position,
xxiv. retracting the pivot,
xxv. unlocking the perforated band,
xxvi. unlocking the wheel to move the vehicle,
III resetting the vehicle security apparatus for next locking use:
xxvii. retracting the pivot,
xxviii. inactivating the servomotor and the worm screw,
xxix. readying the vehicle security apparatus for the next locking cycle.

25. The method of claim 24, wherein the apparatus's electronic compartment locking and/or unlocking remotely via a smart device.

26. The method of claim 24, wherein the vehicle security apparatus preventing unauthorized movement of the vehicle's wheel when parked, protecting the vehicle from theft or tampering.

27. The method of claim 24, wherein the vehicle security apparatus entering a standby mode after completing the locking of the vehicle wheel/s, ensuring tamper detection through onboard sensors of the electronic compartment.

28. The method of claim 24, wherein the electronic compartment having sensors, wherein the sensors verifying the alignment and locking of the pivot, and wherein notifying the user of the non-alignment.
